(19) United States
(12) Patent Application Publication
(10) Pub. No.: US 2007/0080033 A1
(43) Pub. Date: Apr. 12, 2007

(54) Centrifugal brake

(76) Inventor: Ulrich Kowatsch, Leonberg (DE)

Correspondence Address: STRIKER, STRIKER & STENBY, 103 EAST NECK ROAD, HUNTINGTON, NY, 11743, US

(21) Appl. No.: 11/524,770

(22) Filed: Sep. 21, 2006

(30) Foreign Application Priority Data
Sep. 30, 2005 (DE) 10 2005 047 296.6

(51) Int. Cl. F16D 59/00

(52) U.S. Cl. 188/184; 188/185

(57) ABSTRACT

A centrifugal brake has a rotational element, a brake drum that extends at least partially over the rotational element, at least one centrifugal shoe which is movable substantially radially between the rotational element and an inner wall of the brake drum and is located on the rotational element, and a rotational braking device provided for the rotational element and triggered when a specified rotational speed of the rotational element is exceeded.

### CROSS-REFERENCE TO A RELATED APPLIACTION

The invention described and claimed hereinbelow is also described in German Patent Application DE 10 2005 047 296.6 filed on Sep. 30, 2005. This German Patent Application, whose subject matter is incorporated here by reference, provides the basis for a claim of priority of invention under 35 U.S.C. 119(a)-(d).

### BACKGROUND OF THE INVENTION

The present invention relates to a centrifugal brake.

More particularly, the present invention relates to a centrifugal brake with a rotational element and a brake drum that extends at least partially over the rotational element, and at least one centrifugal shoe, which is movable essentially radially between the rotational element and an inner wall of the brake drum and is located on the rotational element.

Centrifugal brakes are generally known. They are not typically used to directly and greatly reduce the number of revolutions, but rather to limit them. Starting at certain drive RPMs, the centrifugal shoes begin to move radially outward from a resting position as a result of the centrifugal force. When the engagement speed is reached, the centrifugal shoes come in contact with the inner wall of the drum. Brake pads, which increase the friction, can be provided between the centrifugal shoes and the drum wall. The brake pads can be installed on the centrifugal shoes or the inner wall of the brake drum. In certain applications, however, it is desirable to bring the rotational element to a complete stop.

### SUMMARY OF THE INVENTION

The object of the present invention, therefore, is to refine a centrifugal brake of the type described initially such that the rotational element can be brought to a complete stop when necessary, particulary when the rotational element exceeds a specified rotational speed.

This object is attained according to the present invention in a surprising and effective manner by providing an additional brake device for the rotational element, which is triggered when the rotational element exceeds a specified rotational speed. This means the centrifugal brake is ineffective up to the specified rotational speed. When the specified rotational speed is exceeded, the additional brake device becomes effective, thereby ensuring that the rotational element is brought to a complete halt. The rotational element can be designed as a drive shaft or a hub, or it can include one of these.

With a particularly preferred embodiment, the brake drum can be a component of the additional braking device, the brake drum being positioned such that it is rotatably movable to a limited extent, and is driven by the at least one centrifugal shoe within a specified angular range when a specified rotational speed is exceeded, thereby triggering the additional braking. Although the brake drum in the related art is positioned in a non-rotatable manner, it can be moved—according to the present invention—within a specified angular range and thereby trigger the additional braking.

An axially movable disk is preferably non-rotatably mounted on the brake drum. Via the axially movable disk, and in interaction with additional elements, an axial braking force can be produced. It can be provided that the disk is locked in the axial direction by a locking mechanism below the specified rotational speed, is axially unlocked above the specified rotational speed, and generates a braking force—which acts axially, in particular—to brake the rotational element. Below the specified rotational speed, the disk can therefore be held by the locking mechanism in the immediate vicinity of the brake drum, in particular in contact with the brake drum. This ensures that the disk is held at a distance away from a brake disk.

When the disk is unlocked, however, i.e., when the rotational speed of the rotational element is above the specified limit, the unlocked disk can interact with at least one brake disk, which is non-rotatably connected with the rotational element and is preferably a diaphragm disk, and with a non-rotatable support bearing. In particular, due to the axial motion of the disk, the brake disk is clamped between the disk and the support bearing.

The braking action can be increased when a brake pad is provided between the disk and the brake disk, and/or between the brake disk and the support bearing. Preferably, brake pads are provided at opposite points on either side of the brake disk.

With a particularly preferred embodiment, several brake disks can be provided, between which plates of the support bearing engage. Friction-increasing brake pads can be provided between the brake disks and the plates. In particular, the brake disks can include brake pads, which are diametrically opposed in the axial direction.

It is particularly preferred when the disk is axially preloaded by at least one axial spring. When the locking mechanism is released, the disk is automatically moved in the direction of the brake disk, and the brake disk is clamped between the disk and the support bearing. The axial spring preferably bears against the brake drum.

It is particularly preferred when the preload of the at least one axial spring is adjustable. This allows the braking torque of the additional brake device to be changed and adjusted.

Different embodiments of the locking mechanism are feasible. An embodiment is feasible with which the locking mechanism includes one or more bearings located in a recess when the rotational speed is below a specified limit. The bearings can hold the disk at a distance away from the support bearing and, therefore, from the brake disk located between them. When the brake drum is rotated, the bearings are displaced out of their recesses and enter a second recess, which is larger than the depth of the first recess. This permits the disk to move close to the support bearing, so that the additional braking takes place.

With a preferred embodiment, the bearings can be located in a bearing cage. When the brake drum is rotated, the bearing cage can be driven, and the bearings can move out of the assigned recesses. The bearing cage is preferably positioned such that it is movable to a limited extent and is coupled with the brake drum such that it allows the rotatability of the brake drum to be limited.

With a preferred embodiment of the present invention, it can be provided that the additional brake device is manually resettable. It can also be provided that the additional brake device is capable of being triggered manually or automatically when a specifiable event occurs. The additional brake device can be triggered, e.g., when it is detected that a drive is running out of true.

In one embodiment, a sensor can be provided, which detects a triggering of the additional braking device and is connected with a signaling device that indicates that the additional braking device has been triggered. As a result, the triggering of the additional braking is easy to detect.

Further features and advantages of the present invention result from the detailed description of exemplary embodiments of the invention presented below with reference to the figures in the drawing, which shows the details that are essential to the present invention. The individual features can be realized individually, or they can be combined in any possible manner in different variations of the present invention.

Exemplary embodiments of the present invention are depicted in the schematic drawing and are described in greater detail in the description below.

### BRIEF DESCRIPTION OF THE DRAWINGS

FIG. 1 is a longitudinal sectional view through a centrifugal brake according to the present invention;

FIG. 2 is a schematic depiction of a locking mechanism;

FIG. 3a is a specific embodiment of a locking mechanism in a locked position; FIG. 3b shows the embodiment of the locking mechanism in FIG. 3b, in an unlocked position.

### DESCRIPTION OF THE PREFERRED EMBODIMENTS

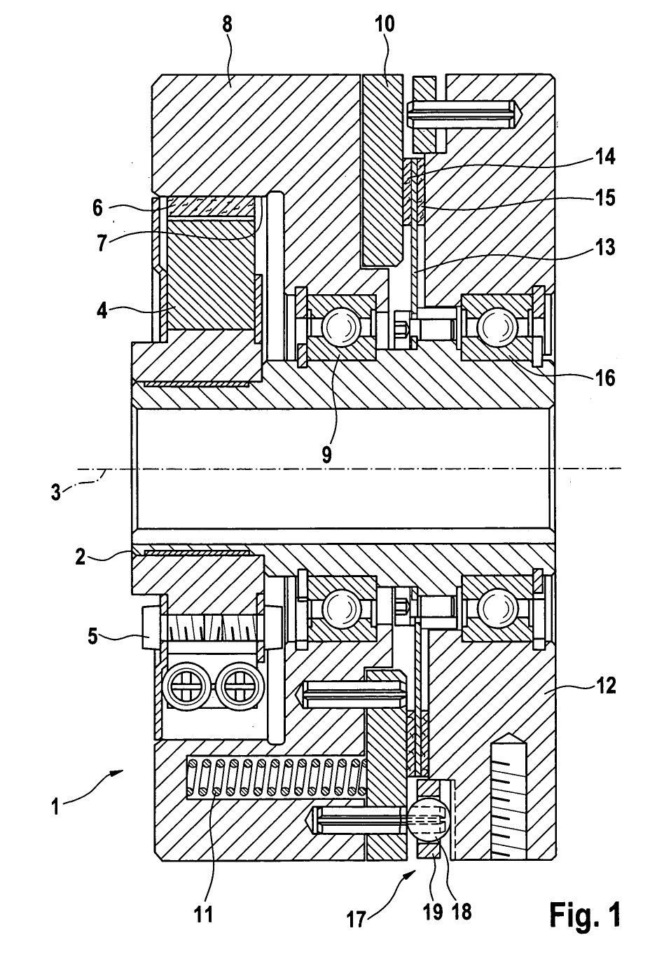

Centrifugal brake 1 shown in FIG. 1 includes a rotational element 2 designed as a hub, which is positioned such that it can rotate around an axis of rotation 3. Centrifugal shoes 4 are located on rotational element 2. They are driven by rotational element 2 when rotational element 2 rotates. Due to the centrifugal force, centrifugal shoes 4 are deflected essentially radially and preferably against a return force when rotational element 2 rotates, so that brake pads 6 of centrifugal shoes 4 come in contact with inner wall 7 of brake drum 8. Brake drum 8 extends over portions of rotational element 2. Ball bearings 9 are located between brake drum 8 and rotational element 2.

A disk 10 is non-rotatably located on brake drum 8. Disk 10 is axially displaceable in certain operating states and bears against brake drum 8 via an axial spring 11. A brake disk 13, which is non-rotatably connected with rotational element 2, is located between disk 10 and a non-rotatable support bearing 12. Brake disk 13 includes brake pads 14, 15, which are located at axially opposing points. Rotational element 12 is rotatably supported in support bearing 12 via ball bearing 16. Due to the axial forces that occur, ball bearings 9, 16 can be designed as angular ball bearings.

Below a specified rotational speed, disk 10 is held against brake drum 8 via a locking mechanism 17. In particular, disk 10 is held at a distance away from support bearing 12 and, therefore, brake disk 13, via bearings 18. In the exemplary embodiment, eight bearings 18 are distributed around the circumference, bearings 18 being located in a bearing cage 19.

When rotational element 2 has reached a specified rotational speed, centrifugal shoes 4 bear with brake pads 6 against brake drum 8 and drive brake drum 8. As a result, bearings 18 are moved out of their resting position, and disk 10 is freed to move axially. Due to preloaded axial spring 11, disk 10 is pressed against brake pad 14 of brake disk 13. This causes brake pad 15 to be pressed against support bearing 12. Brake disk 13 with its brake pads 14, 15 is therefore clamped between disk 10 and support bearing 12, and rotational element 2 is braked until it comes to a standstill.

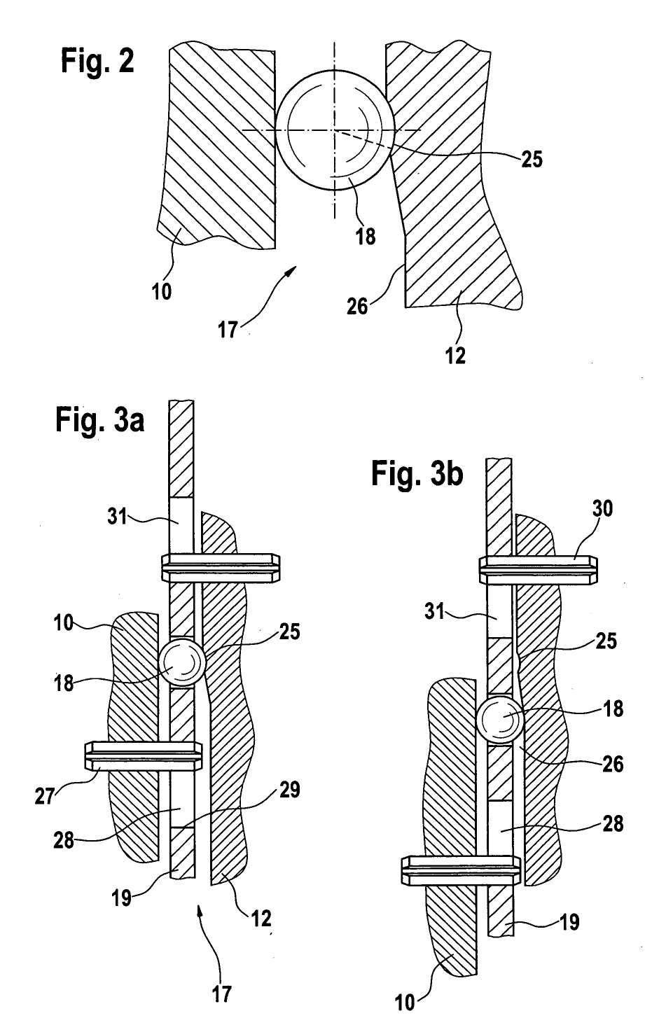

FIG. 2 shows a schematic depiction of locking mechanism 17. A bearing 18 is located in its resting position, i.e., below a specified rotational speed of rotational element 2, in a recess 25 of support bearing 12. When brake drum 8 and disk 10 non-rotatably connected therewith rotates, bearing 18 is moved out of the resting position shown, so that it enters a recess 26. As a result, disk 10 and support bearing 12 can move toward each other.

A possible specific embodiment of locking mechanism 17 is shown in FIG. 3a. In this case as well, bearings 18 are located in a recess 25 of support bearing 12. As a result, it supports disk 10 and holds disk 10 away from support bearing 12. In this case, bearing 18 is located in a bearing cage 19. Projections 27 designed as pins, which are non-rotatably connected with disk 10 and brake drum 8, engage in slots 28 of bearing cage 19.

If brake drum 8 or disk 10 are now rotated, projection 27 reaches lower limit 29 of slot 28—as shown in FIG. 3b—and therefore drives bearing cage 19. As a result, bearings 18 also become disengaged from recess 25 and come to rest in recess 26. Simultaneously, projection 30—which is designed as a pin and is non-rotatably connected with support bearing 12—reaches the opposite limit of slot 31. As a result, bearing cage 19 engages with projection 30 and cannot be moved further. The rotational motion of disk 10 and, therefore, brake drum 8, are therefore also limited. Given that bearing 18 has reached recess 26, it became possible for disk 10 to approach support bearing 12.

It will be understood that each of the elements described above, or two or more together, may also find a useful application in other types of constructions differing from the type described above.

While the invention has been illustrated and described as embodied in a centrifugal brake, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A centrifugal brake, comprising a rotational element; a brake drum that extends at least partially over said rotational element; at least one centrifugal shoe which is movable substantially radially between said rotational element and an inner wall of said brake drum and is located on said rotational element; and a rotational braking device provided for said rotational element and triggered when a specified rotational speed of said rotational element is exceeded.

2. A centrifugal brake as defined in claim 1, wherein said brake drum is a component of said additional braking device and positioned such that it is rotatably movable to a limited extent; and further comprising at least one centrifugal shoe which drives said braking drum with a specified angular range when a specified rotational speed is exceeded, thereby triggering an additional braking.

3. A centrifugal brake as defined in claim 1; and further comprising an axially movable disk which is non-rotatably mounted on said brake drum.

4. A centrifugal brake as defined in claim 3; and further comprising a locking mechanism which is configured for locking said disk in an axial direction below a specified rotational speed and unlocking said disk above said specified rotational speed, so that a braking force is generated which acts axially.

5. A centrifugal brake as defined in claim 4, wherein said disk is configured so that it generates a braking force which acts axially to brake said rotational element.

6. A centrifugal brake as defined in claim 5; and further comprising at least one brake disk with which said disk interacts when unlocked and which is non-rotatably connected with said rotational element and with a non-rotatable support bearing.

7. A centrifugal brake as defined in claim 6, wherein said at least one brake disk is configured as a diaphragm disk.

8. A centrifugal brake as defined in claim 6; and further comprising a brake pad provided at a location selected from the group consisting of between said disk and said brake disk, between said brake disk and said support bearing, and both.

9. A centrifugal brake as defined in claim 6, wherein a plurality of said brake disks are provided which engage between plates of said support bearing.

10. A centrifugal brake as defined in claim 3; and further comprisnig at least one axial spring which axially preloads said disk.

11. A centrifugal brake as defined in claim 10, wherein said at least one axial spring is configured so that a preload of said at least one axial spring is adjustable.

12. A centrifugal brake as defined in claim 6, wherein said locking mechanism includes at least one bearing located in a recess of said support bearing when the rotational speed is below a specified limit.

13. A centrifugal brake as defined in claim 12; and further comprising a plurality of said bearings which are located in a bearing cage.

14. A centrifugal brake as defined in claim 1, wherein said additional braking device is configured so that it is manually resettable.

15. A centrifugal brake as defined in claim 1, wherein said additional braking device is configured so that it is triggerable in a manner selected from the group consisting of manually and automatically, when a specifiable event occurs.

16. A centrifugal brake as defined in claim 1; and further comprising a sensor configured for detecting a triggering of an additional braking device; and a signaling device connected with said sensor and being configured to indicate that said additional braking device has been triggered.
